(19) United States
(12) Patent Application Publication
(10) Pub. No.: US 2025/0244652 A1
(43) Pub. Date: Jul. 31, 2025

(54) PROJECTION DEVICE

(71) Applicant: Qisda Corporation, Taoyuan City (TW)

(72) Inventors: Chih-Shiung Chien, Taoyuan City (TW); Ming-Kuen Lin, Taoyuan City (TW); Yi-Ling Lo, Taoyuan City (TW)

(73) Assignee: Qisda Corporation, Taoyuan City (TW)

(21) Appl. No.: 19/015,588

(22) Filed: Jan. 9, 2025

(30) Foreign Application Priority Data
Jan. 29, 2024 (TW) 113103398

(51) Int. Cl. G03B 21/20

(52) U.S. Cl. CPC G03B 21/204; G03B 21/2066; G03B 21/208

(57) ABSTRACT

A projection device includes a light source device including a light source configured to emit an excitation beam, and a light splitting element, a quarter-wave plate, a filter element, and a wavelength conversion element located on a transmission path of the excitation beam. The filter element includes first and second filter regions and a reflective region, and enables the first and second filter regions and the reflective region to enter the transmission path of the excitation beam sequentially. The excitation beam penetrates through the first and second filter regions, and is reflected by the reflective region to form a reflected beam. The excitation beam passes through the filter element and is incident on the wavelength conversion element, causing the wavelength conversion element to generate a wavelength-converted beam, and the wavelength-converted beam is incident on the filter element.

### CROSS-REFERENCE TO RELATED APPLICATION

This application claims the priority benefit of Taiwan application serial no. 113103398, filed on Jan. 29, 2024. The entirety of the above-mentioned patent application is hereby incorporated by reference herein and made a part of this specification.

### BACKGROUND

### Technical Field

The disclosure relates to a projection device.

### Description of Related Art

In a projection system, high-quality projected images have a wide application value. Therefore, to efficiently generate high-quality multiple colors of light while achieving requirements of reducing system volume and cost has become an important issue in this technical field.

### SUMMARY

The disclosure provides a projection device including a light source device, wherein the light source device includes a light source, a light splitting element, a quarter-wave plate, a filter element, and a wavelength conversion element. The light source is configured to emit an excitation beam, and the light splitting element, the quarter-wave plate, the filter element, and the wavelength conversion element are located on a transmission path of the excitation beam. The filter element includes a first filter region, a second filter region, and a reflective region. The filter element enables the first filter region, the second filter region, and the reflective region to enter the transmission path of the excitation beam sequentially, wherein the excitation beam penetrates through the first filter region and the second filter region, and the excitation beam is reflected by the reflective region to form a reflected beam. The excitation beam passes through the filter element and is incident on the wavelength conversion element to cause the wavelength conversion element to generate a wavelength-converted beam, and the wavelength-converted beam is incident on the filter element. The wavelength-converted beam is incident on the first filter region of the filter element to generate first color light, and the wavelength-converted beam is incident on the second filter region of the filter element to generate second color light. The first color light, the second color light, and the reflected beam form an illumination beam.

In an embodiment of the disclosure, the light splitting element is configured to reflect the excitation beam having a first linear polarization direction.

In an embodiment of the disclosure, the projection device further includes a uniformizing element configured on the transmission path of the excitation beam and located between the light splitting element and the filter element. The uniformizing element is configured to uniformize the excitation beam, the first color light, the second color light, and the reflected beam incident on the uniformizing element.

In an embodiment of the disclosure, the uniformizing element is a fly-eye lens.

In an embodiment of the disclosure, the projection device further includes a uniformizing element configured on the transmission path of the excitation beam and located between the filter element and the wavelength conversion element. The uniformizing element is configured to uniformize the excitation beam and the wavelength-converted beam incident on the uniformizing element.

In an embodiment of the disclosure, the uniformizing element is a light guide column.

In an embodiment of the disclosure, the light guide column is hollow or solid.

In an embodiment of the disclosure, an opening area of the light guide column on a side of the filter element is A1, and an opening area on a side of the wavelength conversion element is A2, then A1≥A2.

In an embodiment of the disclosure, the excitation beam is blue light.

In an embodiment of the disclosure, the filter element rotates along a central axis.

In an embodiment of the disclosure, the first filter region, the second filter region, and the reflective region of the filter element have a same area.

In an embodiment of the disclosure, the first filter region allows blue light beam and red light beam to pass through, and the second filter region allows blue light beam and green light beam to pass through.

In an embodiment of the disclosure, the wavelength-converted beam is yellow light.

In an embodiment of the disclosure, the first color light is red light, and the second color light is green light.

In an embodiment of the disclosure, a surface of the reflective region of the filter element has microstructures.

In an embodiment of the disclosure, the filter element further includes a full penetration region allowing the excitation beam and the wavelength-converted beam to pass through.

In an embodiment of the disclosure, the projection device further includes a refractive element, a light valve, and a projection lens, where the illumination beam passes through the refractive element and is then incident on the light valve, the light valve converts the illumination beam into an image beam, and the projection lens is configured on an optical path of the image beam.

In an embodiment of the disclosure, the refractive element is a lens or curved mirror with a positive refractive power.

In an embodiment of the disclosure, the projection device further includes a refracting mirror. The refracting mirror is located on an optical path of the illumination beam, and the refracting mirror is located between the light splitting element and the refractive element.

In an embodiment of the disclosure, the projection device further includes a total reflection lens. The total reflection lens is located on the optical path of the illumination beam, and the total reflection lens is located between the refractive element and the light valve.

Based on the above description, in the projection device of the disclosure, a light source of a single color light and a wavelength conversion element are used to generate wavelength-converted beams with two colors. By using the characteristics of the first filter region and the second filter region of the filter element that allow two colors of light to pass through, the first color light and the second color light are separated. Therefore, the structure of the light source device is effectively reduced, and multiple colors of light may be generated without the need for multiple wavelength conversion devices.

### BRIEF DESCRIPTION OF THE DRAWINGS

FIG. 1A is a schematic diagram of a light source device according to an embodiment of the disclosure.

FIG. 1B is a schematic diagram of a light source device according to an embodiment of the disclosure.

FIG. 2 is a schematic diagram of a light source device according to an embodiment of the disclosure.

FIG. 3 is a schematic diagram of a light source device according to an embodiment of the disclosure.

FIG. 4A is a schematic diagram of a filter element according to an embodiment of the disclosure.

FIG. 4B is a schematic diagram of a filter element according to an embodiment of the disclosure.

FIG. 5 is a schematic diagram of a projection device according to an embodiment of the disclosure.

FIG. 6 is a schematic diagram of a projection device according to an embodiment of the disclosure.

FIG. 7 is a schematic diagram of a projection device according to an embodiment of the disclosure.

FIG. 8 is a schematic diagram of a projection device according to an embodiment of the disclosure.

FIG. 9 is a schematic diagram of a projection device according to an embodiment of the disclosure.

### DESCRIPTION OF THE EMBODIMENTS

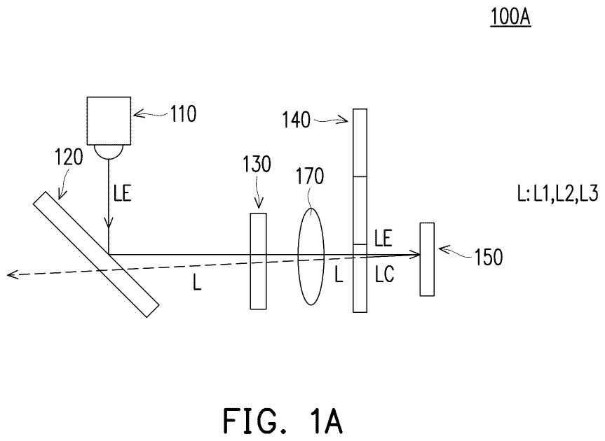

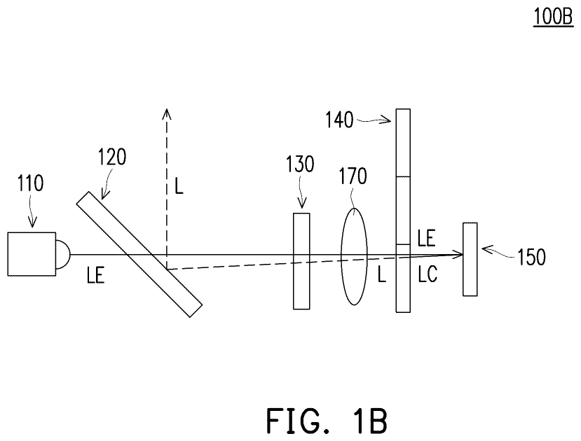

FIG. 1A is a schematic diagram of a light source device according to an embodiment of the disclosure. Referring to FIG. 1A, the disclosure provides a projection device including a light source device 100A. As shown in FIG. 1A, the light source device 100A includes a light source 110, a light splitting element 120, a quarter-wave plate 130, a filter element 140 and a wavelength conversion element 150.

The light source 110 is configured to emit an excitation beam LE, and the light splitting element 120, the quarter-wave plate 130, the filter element 140, and the wavelength conversion element 150 are sequentially located on a transmission path of the excitation beam LE.

In some embodiments, the light source 110 is a laser light source, and the excitation beam LE is blue light. For example, the light source 110 may include a plurality of blue laser diodes arranged in an array. In some embodiments, the light source 110 may emit a light beam with a specific polarization direction, for example, a light beam with an S-polarization direction, or a light beam with a P-polarization direction. In the embodiment, the light source 110 may emit the excitation beam LE with the S-polarization direction.

The excitation beam LE emitted by the light source 110 is incident on the light splitting element 120. In the embodiment, the light splitting element 120 is configured to reflect incident light with a first linear polarization direction and to transmit incident light with a second linear polarization direction. In the embodiment, the first linear polarization direction is S-polarization, and the second linear polarization direction is P-polarization. Therefore, in the embodiment, the light splitting element 120 is configured to reflect the incident light with S-polarization and transmit the incident light with P-polarization. In the embodiment, the incident light is the excitation beam LE.

Therefore, in the embodiment, after the excitation beam LE with S-polarization emitted by the light source 110 is incident on the light splitting element 120, it is reflected by the light splitting element 120. In another embodiment, if the excitation beam emitted by the light source 110 has both S-polarization and P-polarization, the excitation beam LE with P-polarization may penetrate through the light splitting element 120 and leave the system.

In other embodiments, the first linear polarization direction may be P-polarization, and the second linear polarization direction may be S-polarization. Namely, the light splitting element 120 is configured to reflect the incident light with P-polarization and allow the incident light with S-polarization to pass through.

The excitation beam LE reflected by the light splitting element 120 is incident on the quarter-wave plate 130 located on the optical path, and the polarization direction of the excitation beam LE is changed from the first linear polarization direction to circular polarization, and is incident on the filter element 140.

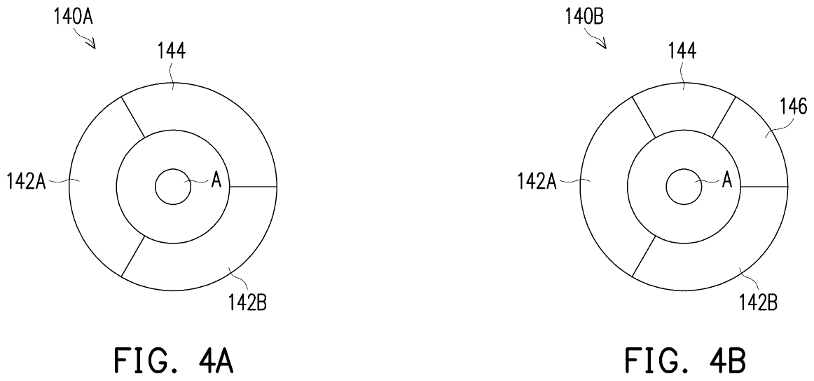

Referring to FIG. 4A for a structure of the filter element 140. FIG. 4A is a schematic diagram of a filter element according to an embodiment of the disclosure. As shown in FIG. 4A, a filter element 140A is an embodiment of the filter element 140 shown in FIG. 1.

The filter element 140A includes a first filter region 142A, a second filter region 142B, and a reflective region 144. The filter element 140A has a central axis A, and the filter element 140A rotates along the central axis A. When the filter element 140A rotates along the central axis A, the filter element 140 enables the first filter region 142A, the second filter region 142B, and the reflective region 144 to enter the transmission path of the excitation beam LE sequentially. The excitation beam LE penetrates through the first filter region 142A and the second filter region 142B, and is reflected by the reflective region 144 to form a reflected beam L3.

In some embodiments, the first filter region 142A is a dichroic filter, which allows two types of color light to pass through and prevent lights of other colors from passing through. In the embodiment, the first filter region 142A is a magenta filter that allows blue beam and red beam to pass through.

In some embodiments, the second filter region 142B is a dichroic filter, which allows two types of color light to pass through and prevent lights of other colors from passing through. In the embodiment, the second filter region 142B is a cyan filter that allows blue beam and green beam to pass through.

In some embodiments, the reflective region 144 is configured to reflect the excitation beam LE to form the reflected beam L3. In some embodiments, the reflective region 144 is a specular reflective element, and the specular reflective element may be blue light reflective glass. According to other embodiments, a material of the reflective region 144 may be metal coating, such as silver, aluminum, dielectric coating, etc., with a thickness less than 5 μm.

In some embodiments, a surface of the reflective region 144 of the filter element 140 has a diffusion device to change a shape of the reflected beam L3. In some embodiments, the diffusion device includes microstructures or diffusion particles, or other devices having similar functions.

FIG. 4B is a schematic diagram of a filter element according to an embodiment of the disclosure. As shown in FIG. 4B, a filter element 140B is an embodiment of the filter element 140 shown in FIG. 1. The filter element 140B shown in FIG. 4B is similar to the filter element 140A shown in FIG. 4A, and the similarities there between will not be repeated. Compared with the filter element 140A shown in FIG. 4A, the filter element 140B shown in FIG. 4B further includes a full penetration region 146 in addition to the first filter region 142A, the second green light region 142B, and the reflective region 144, which allows all of the light beams that pass through the full penetration region 146 to pass through, i.e., allows the excitation beam LE and the wavelength-converted beam LC to pass through.

Therefore, when the excitation beam LE is incident on the filter element 140, a part of the excitation beam LE passes through the filter element 140 and is incident on the wavelength conversion element 150, causing the wavelength conversion element 150 to generate a wavelength-converted beam LC, and the wavelength-converted beam LC is incident on the filter element 140. A part of the excitation beam LE is reflected by the filter element 140.

In the embodiment, the wavelength conversion element 150 is a material with a wavelength conversion capability, such as phosphor or other substances with the wavelength conversion capability, for converting the excitation beam LE into the wavelength-converted beam LC having a wavelength different from that of the excitation beam LE. In the embodiment, the wavelength conversion element 150 may absorb blue light and convert the blue light of the excitation beam LE into yellow light of the wavelength-converted beam LC. Since yellow light is a combination of green light and red light, the wavelength-converted beam LC is equivalent to a combination of green light and red light. In addition, at this time, a polarization state of the wavelength-converted beam LC is the same as that of the excitation beam LE incident on the wavelength conversion element 150.

The wavelength-converted beam LC emitted by the wavelength conversion element 150 is incident on the filter element 140. Referring to FIG. 4A and FIG. 4B at the same time, when the wavelength-converted beam LC is incident on the first filter region 142A of the filter element 140A or the filter element 140B, the first color light L1 is generated, and when the wavelength-converted beam LC is incident on the second filter region 142B of the filter element 140, the second color light L2 is generated.

To be specific, since the first filter region 142A is a magenta filter that allows blue light beam and red light beam to pass through, when the wavelength-converted beam LC is incident on the first filter region 142A of the filter element 140A or the filter element 140B, the wavelength-converted beam LC is filtered by the first filter region 142A to generate the first color light L1. In the embodiment, the first color light L1 is a red light part of the wavelength-converted beam LC. A green light part of the wavelength-converted beam LC is blocked by the first filter region 142A.

On the other hand, since the second filter region 142B is a cyan filter that allows the blue light beam and the green light beam to pass through, when the wavelength-converted beam LC is incident on the second filter region 142B of the filter element 140A or the filter element 140B, the wavelength-converted beam LC is filtered by the second filter region 142B to generate the second color light L2. In the embodiment, the second color light L2 is the green light part of the wavelength-converted beam LC. The red light part of the wavelength-converted beam LC is blocked by the second filter region 142B.

When the wavelength-converted beam LC is incident on the reflective region 144, the wavelength-converted beam LC does not penetrate through the reflective region 144.

Therefore, when the wavelength-converted beam LC passes through the filter element 140, the first color light L1 (i.e., red light) and the second color light L2 (i.e., green light) may be generated. In addition, there is also a reflected beam L3 (i.e., blue light) formed through reflection of the reflective region 144. Therefore, the first color light L1, the second color light L2, and the reflected beam L3 form an illumination beam L.

In other embodiments, when the wavelength-converted beam LC is incident on the full penetration region 146 of the filter element 140B as shown in FIG. 4B, the wavelength-converted beam LC penetrates through the full penetration region 146. Since the wavelength-converted beam LC is a combination of red light and green light, which is equivalent to the combination of the first color light L1 (red light) and the second color light L2 (green light), components of the first color light L1 and the second color light L2 in the illumination beam L may be increased. In addition, through the full penetration region 146, a brightness and a saturation of the illumination beam may be increased.

In some embodiments, the first filter region 142A, the second filter region 142B, and the reflective region 144 of the filter element 140A shown in FIG. 4A have a same area. Therefore, when the filter element 140 is rotated to sequentially cut into the optical path of the excitation beam LE, equal amounts of the first color light L1, the second color light L2, and the reflected beam L3 may be generated. However, in other embodiments, the areas of the first filter region 142A, the second filter region 142B, and the reflective region 144 may also have unequal areas according to a required color light ratio combination, which is not limited by the disclosure.

In some embodiments, the areas of the first filter region 142A, the second filter region 142B, the reflective region 144, and the full penetration region 146 of the filter element 140B as shown in FIG. 4B may have equal or unequal areas according to a required color light ratio combination, which is not limited by the disclosure.

The illumination beam L emitted by the filter element 140 is incident on the quarter-wave plate 130 along the optical path. At this time, the polarization directions of the first color light L1, the second color light L2, and the reflected beam L3 in the illumination beam L change from circular polarization to linear polarization direction again, but at this time, the linear polarization direction changes from the S polarization of the excitation beam LE emitted by the light source 110 to the P polarization, which is the second linear polarization direction.

The illumination beam L passing through the quarter-wave plate 130 is incident on the light splitting element 120 along the optical path. Since the illumination beam L is P polarization, and the light splitting element 120 may allow the incident light beam with P polarization to pass through, the illumination beam L penetrates through the light splitting element 120 and proceeds along the optical path.

In some embodiments, the light source device 100A further includes a lens 170 located between the quarter-wave plate 130 and the filter element 140. The lens 170 generally refers to a lens with a light converging function, which is configured to change characteristics of the excitation beam LE and the illumination beam L.

Therefore, by using the light source device 100A as shown in FIG. 1, the light source 110 of a single color light and a wavelength conversion element 150 may be used to generate the wavelength-converted beam LC with two colors. Based on the characteristics of the first filter region 142A and the second filter region 142B of the filter element 140 that allows two color lights to pass through, the first color light L1 and the second color light L2 are separated. Therefore, the light source device 100A may effectively reduce the structure of the light source device and may generate multiple color lights without the need for multiple wavelength conversion devices.

FIG. 1B is a schematic diagram of a light source device according to an embodiment of the disclosure. A light source device 100B shown in FIG. 1B is similar to the light source device 100A shown in FIG. 1A, and the similarities there between will not be repeated. A difference between the light source device 100B shown in FIG. 1B and the light source device 100A shown in FIG. 1A is that the polarization direction of the excitation beam LE emitted by the light source 110 is P polarization. Therefore, when being incident on the light splitting element 120, the excitation beam LE may penetrate through the light splitting element 120, and sequentially passes through the quarter-wave plate 130, the filter element 140, the wavelength conversion element 150, and return to the light splitting element 120 along the original optical path. When the illumination beam L passes through the light splitting element 120, after the excitation beam LE with P polarization passes through the quarter-wave plate 130 twice, it changes to S polarization, and may be reflected by the light splitting element 120, and proceeds along the optical path.

In the embodiment, the light source 110 is located on one side of the light splitting element 120, and the quarter-wave plate 130, the filter element 140, and the wavelength conversion element 150 are all located on the other opposite side of the light splitting element 120.

Therefore, an appropriate light source system may be selected according to whether the linear polarization direction of the light required by the system is S polarization or P polarization, as shown in the light source system 100A of FIG. 1A or the light source system 100B of FIG. 1B.

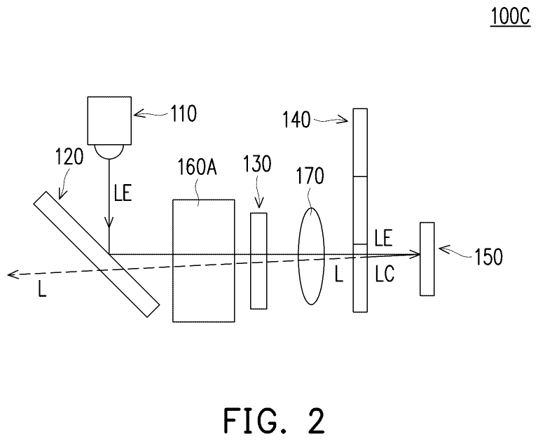

FIG. 2 is a schematic diagram of a light source device according to an embodiment of the disclosure. A light source device 100C shown in FIG. 2 is similar to the light source device 100A shown in FIG. 1A, and the similarities there between will not be repeated. A difference between the light source device 100C shown in FIG. 2 and the light source device 100A shown in FIG. 1A is that the light source device 100C further includes a uniformizing element 160A, which is configured on the transmission path of the excitation beam LE and is located between the light splitting element 120 and the filter element 140. In some embodiments, the uniformizing element 160A is located between the light splitting element 120 and the quarter-wave plate 130. The uniformizing element 160A is configured to uniformize the excitation beam LE, the first color light L1, the second color light L2, and the reflected beam L3 that are incident on the uniformizing element 160A.

Specifically, when the excitation beam LE enters the uniformizing element 160A, the excitation beam LE may be shaped by the uniformizing element 160A, for example, the excitation beam LE with a circular spot is changed to the excitation beam LE with a rectangular spot, and the shaped excitation beam LE is incident on the wavelength conversion element 150 after passing through the filter element 140. On the other hand, when the illumination beam L having the first color light L1, the second color light L2, and the reflected beam L3 passes through the uniformizing element 160A, the uniformizing element 160A may shape the illumination beam L having the first color light L1, the second color light L2, and the reflected beam L3, so that the illumination beam L has a desired shape.

Therefore, in the embodiment, the reflected beam L3 of the illumination beam L, i.e., the blue light, may pass through the uniformizing element 160A twice, i.e., it is shaped twice. The first color light L1 and the second color light L2 of the illumination beam may pass through the uniformizing element 160A once, i.e., they are shaped once.

In some embodiments, the uniformizing element 160A is a fly eye lens, or other lenses with the similar function, but the disclosure is not limited thereto.

In some embodiments, the uniformizing element 160A may also be configured on the transmission path of the excitation beam LE of the light source device 100B of FIG. 1B in a manner similar to that of FIG. 2, and is located between the light splitting element 120 and the filter element 140. In some embodiments, the uniformizing element 160A is located between the light splitting element 120 and the quarter-wave plate 130.

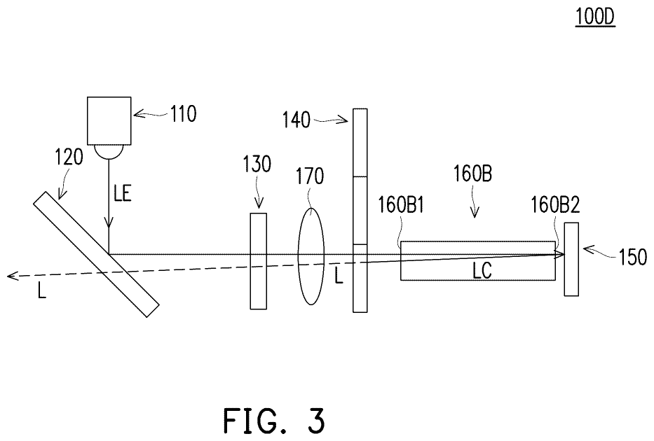

FIG. 3 is a schematic diagram of a light source device according to an embodiment of the disclosure. A light source device 100D shown in FIG. 3 is similar to the light source device 100A shown in FIG. 1A, and the similarities there between will not be repeated. A difference between the light source device 100D shown in FIG. 3 and the light source device 100A shown in FIG. 1A is that the light source device 100D further includes a uniformizing element 160B, which is configured on the transmission path of the excitation beam LE and is located between the filter element 140 and the wavelength conversion element 150. The uniformizing element 160B is configured to uniformize the excitation beam LE and the wavelength-converted beam LC incident on the uniformizing element 160B.

Specifically, when the excitation beam LE enters the uniformizing element 160B, the excitation beam LE may be shaped by the uniformizing element 160B, for example, the excitation beam LE with a circular spot is changed to the excitation beam LE with a rectangular spot, and the shaped excitation beam LE is incident on the wavelength conversion element 150. On the other hand, when the wavelength-converted beam LC emitted by the wavelength conversion element 150 passes through the uniformizing element 160A, the uniformizing element 160A may shape the wavelength-converted beam LC, so that the wavelength-converted beam LC has a desired shape, and the filter element 140 filters the shaped wavelength-converted beam LC.

Therefore, in the embodiment, the reflected beam L3 of the illumination beam L does not pass through the uniformizing element 160B, i.e., it is not shaped. The first color light L1 and the second color light L2 of the illumination beam will both pass through the uniformizing element 160B once, i.e., they are shaped once.

In some embodiments, the uniformizing element 160B is a light guide column, or other elements having the similar function, which is not limited by the disclosure. In some embodiments, the uniformizing element 160B, i.e., the light guide column, is hollow or solid.

In some embodiments, an area of an opening 160B1 of the light guide column on the side of the filter element 140 is A1, and an area of an opening 160B2 on the side of the wavelength conversion element 150 side is A2, and A1=A2. Therefore, when the excitation beam LE is incident on the uniformizing element 160B, in addition to shaping, the uniformizing element 160B also has a converging effect.

In some embodiments, the uniformizing element 160B may also be configured on the transmission path of the excitation beam LE of the light source device 100B of FIG. 1B in a manner similar to that of FIG. 3, and is located between the filter element 140 and the wavelength conversion element 150.

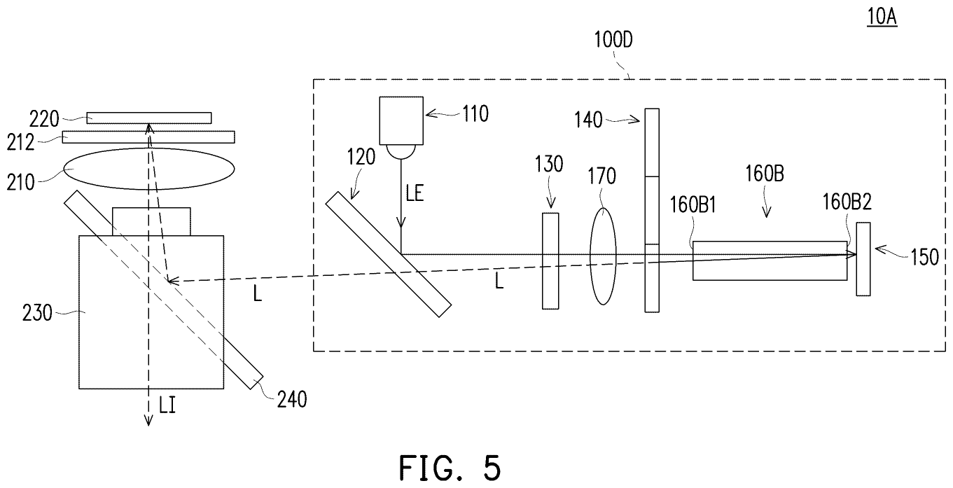

FIG. 5 is a schematic diagram of a projection device according to an embodiment of the disclosure. Referring to FIG. 5, a projection device 10A of FIG. 5 includes the light source device 100D for generating an illumination beam L. The light source device 100D may also be any of the light source device 100A shown in FIG. 1A, the light source device 100B shown in FIG. 1B, or the light source device 100C shown in FIG. 2, which is not limited by the disclosure. The filter element 140 in the light source device 100D may be any of the filter element 140A shown in FIG. 4A or the filter element 140B shown in FIG. 4B, which is not limited by the disclosure.

As shown in FIG. 5, the projection device 10A further includes a refractive element 210, a light valve 220, and a projection lens 230. The illumination beam L emitted by the light source device 100D passes through the refractive element 210 and is then incident on the light valve 220. The light valve 220 converts the illumination beam L into an image beam LI, and the projection lens 230 is configured on an optical path of the image beam LI.

Specifically, the refractive element 210 generally refers to a lens with a light converging function, so that the illumination beam L may be projected on the light valve 220. Specifically, in some embodiments, refractive element 210 is a lens with positive refractive power.

After the illumination beam L passes through the refractive element 210, it is incident on a refracting mirror 240. The refracting mirror 240 is located on the optical path of the illumination beam L. The refracting mirror 240 is located between the light splitting element 120 and the refractive element 210 to change the optical path of the illumination beam L. In some embodiments, the refracting mirror 240 may be a plane reflector, a curved reflector, or a one with similar function, which is not limited by the disclosure.

The illumination beam L is reflected by the refracting mirror 240, and passes through an optical actuator 212 to enter the light valve 220. The light valve 220 is adapted to convert the illumination beam L into an image beam LI. In the embodiment, the light valve 220 is, for example, a digital micro-mirror device (DMD) or a liquid-crystal-on-silicon panel (LCOS panel). However, in other embodiments, the light valve 220 may also be a transmissive liquid crystal panel or other beam modulator. The image beam LI penetrates through a repeatedly vibrating lens on the optical actuator 212 to increase an image resolution.

The projection lens 230 is located on the transmission path of the image beam LI and is adapted to project the image beam LI onto a screen (not shown) to form an image screen. In the embodiment, the projection lens 230 is a combination of one or more optical lenses with refractive power, and the optical lenses include, for example, various combinations of non-planar lenses such as biconcave lenses, biconvex lenses, concavo-convex lenses, convexo-concave lenses, plano-convex lenses, plano-concave lenses, etc. The disclosure does not limit the pattern and type of the projection lens 230.

After the illumination beam L converges on the light valve 220, the light valve 220 sequentially converts the illumination beam L into the image beam LI of different colors and transmits the same to the projection lens 230. Therefore, the image screen projected by the image beam LI converted by the light valve 220 may become a color image.

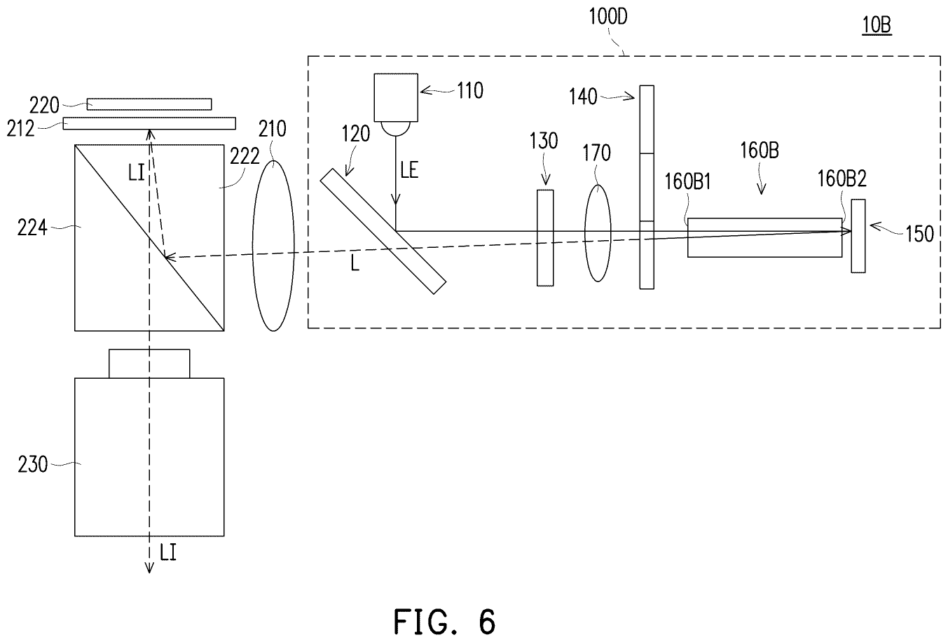

FIG. 6 is a schematic diagram of a projection device according to an embodiment of the disclosure. A projection device 10B shown in FIG. 6 is similar to the projection device 10A shown in FIG. 5, and the similarities there between will not be repeated. A difference between the projection device 10B shown in FIG. 6 and the projection device 10A shown in FIG. 5 is that in FIG. 6, the projection device 10B further includes a total reflection lens 222. The total reflection lens 222 is located on the optical path of the illumination beam L, and is located between the refractive element 210 and the light valve 220. After the illumination beam L passes through the refractive element 210, it is incident on the total reflection lens 222.

The total reflection lens 222 is a right-angled triangle. The illumination beam L is incident on the total reflection lens 222. After total reflection by a long side of the total reflection lens 222, the illumination beam L is incident on the optical actuator 212 and the light valve 220. After the light valve 220 converts the illumination beam L into the image beam LI, the image beam LI passes through the total reflection lens 222 and a lens 224 and is incident on the projection lens 230.

Therefore, through the combination of the total reflection lens 222 and the lens 224, an effect of changing the optical paths of the illumination beam L and the image beam LI may be achieved.

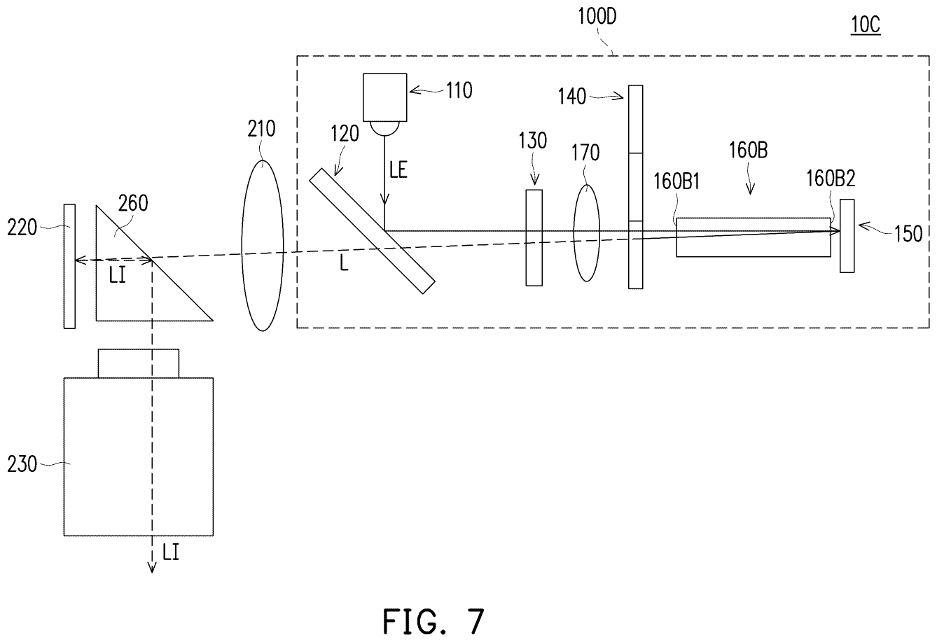

FIG. 7 is a schematic diagram of a projection device according to an embodiment of the disclosure. A projection device 10C shown in FIG. 7 is similar to the projection device 10A shown in FIG. 5, and the similarities there between will not be repeated. A difference between the projection device 10C shown in FIG. 7 and the projection device 10A shown in FIG. 5 is that in FIG. 7, after the illumination beam L passes through the refractive element 210, it is incident on a total reflection lens 260.

The total reflection lens 260 is a right-angled triangle. The illumination beam L is incident on the total reflection lens 260, and after passing through a long side of the total reflection lens 260 and penetrating through the total reflection lens 260, the illumination beam L is incident on the light valve 220. After the light valve 220 converts the illumination beam L into the image beam LI, after total reflection of the long side of the total reflection lens 260, the image beam LI is incident on the projection lens 230.

Therefore, through the total reflection lens 260, the effect of changing the optical paths of the illumination beam L and the image beam LI may be achieved.

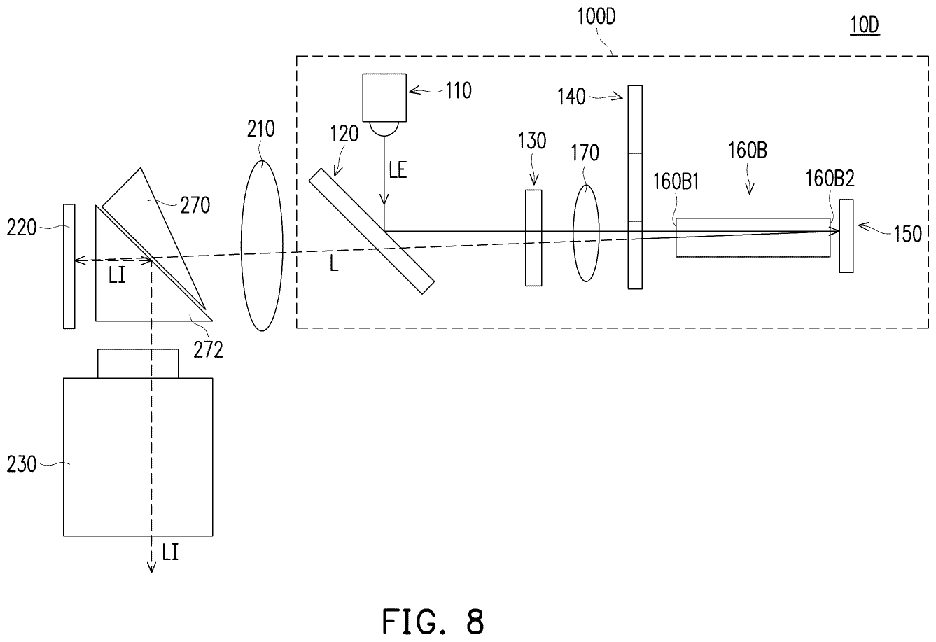

FIG. 8 is a schematic diagram of a projection device according to an embodiment of the disclosure. A projection device 10D shown in FIG. 8 is similar to the projection device 10A shown in FIG. 5, and the similarities there between will not be repeated. A difference between the projection device 10D shown in FIG. 8 and the projection device 10A shown in FIG. 5 is that in FIG. 8, after the illumination beam L passes through the refractive element 210 and passes through a lens 270 and a total reflection lens 272, the illumination beam L is incident on the light valve 220.

After the light valve 220 converts the illumination beam L into the image beam LI, the image beam LI is incident on the total reflection lens 272, and after total reflection by the long side of the total reflection lens 272, the image beam LI is incident on the projection lens 230.

Therefore, through the combination of the lens 270 and the total reflection lens 272, the effect of changing the optical paths of the illumination beam L and the image beam LI may be achieved.

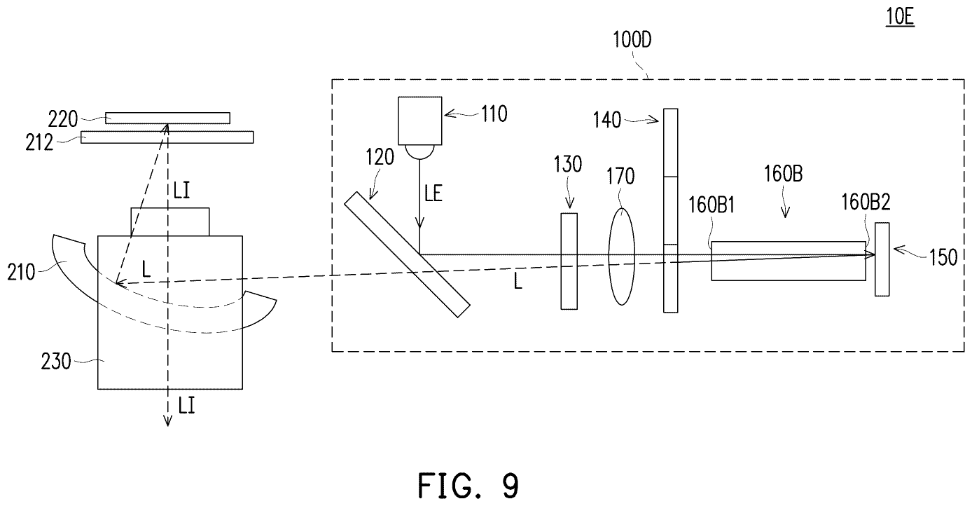

FIG. 9 is a schematic diagram of a projection device according to an embodiment of the disclosure. A projection device 10E shown in FIG. 9 is similar to the projection device 10A shown in FIG. 5, and the similarities there between will not be repeated. A difference between the projection device 10F shown in FIG. 9 and the projection device 10A shown in FIG. 5 is that in FIG. 9, the refractive element 210 is a curved mirror with positive refractive power. After the illumination beam L is reflected by the refractive element 210, it is incident on the light valve 220 through the optical actuator 212. The light valve 220 converts the illumination beam L into the image beam LI, and the image beam LI is incident on the projection lens 230.

Therefore, through the refractive element 210, the effect of changing the optical path of the illumination beam L may be achieved.

In summary, in the projection device of the disclosure, a light source of a single color light and a wavelength conversion element may be used to generate wavelength-converted beams with two colors. By using the characteristics of the first filter region and the second filter region of the filter element that allow two colors of light to pass through, the first color light and the second color light are separated. Therefore, the structure of the light source device is effectively reduced, and multiple colors of light may be generated without the need for multiple wavelength conversion devices.

What is claimed is:

1. A projection device, comprising a light source device, wherein
the light source device comprises a light source, a light splitting element, a quarter-wave plate, a filter element, and a wavelength conversion element, wherein,
the light source is configured to emit an excitation beam, and the light splitting element, the quarter-wave plate, the filter element, and the wavelength conversion element are located on a transmission path of the excitation beam;
the filter element comprises a first filter region, a second filter region, and a reflective region, the filter element enables the first filter region, the second filter region, and the reflective region to enter the transmission path of the excitation beam sequentially, the excitation beam penetrates through the first filter region and the second filter region, and the excitation beam is reflected by the reflective region to form a reflected beam;
the excitation beam passes through the filter element and is incident on the wavelength conversion element to cause the wavelength conversion element to generate a wavelength-converted beam, and the wavelength-converted beam is incident on the filter element;
the wavelength-converted beam is incident on the first filter region of the filter element to generate first color light, and the wavelength-converted beam is incident on the second filter region of the filter element to generate second color light,
the first color light, the second color light, and the reflected beam form an illumination beam.

2. The projection device as claimed in claim 1, wherein the light splitting element is configured to reflect the excitation beam having a first linear polarization direction.

3. The projection device as claimed in claim 1, further comprising:
a uniformizing element, configured on the transmission path of the excitation beam, and located between the light splitting element and the filter element, wherein the uniformizing element is configured to uniformize the excitation beam, the first color light, the second color light, and the reflected beam incident on the uniformizing element.

4. The projection device as claimed in claim 1, wherein a uniformizing element is a fly-eye lens.

5. The projection device as claimed in claim 1, further comprising:
a uniformizing element, configured on the transmission path of the excitation beam, and located between the filter element and the wavelength conversion element, wherein the uniformizing element is configured to uniformize the excitation beam and the wavelength-converted beam incident on the uniformizing element.

6. The projection device as claimed in claim 5, wherein the uniformizing element is a light guide column.

7. The projection device as claimed in claim 6, wherein the light guide column is hollow or solid.

8. The projection device as claimed in claim 6, wherein an opening area of the light guide column on a side of the filter element is A1, and an opening area on a side of the wavelength conversion element is A2, then A1≥A2.

9. The projection device as claimed in claim 1, wherein the excitation beam is blue light.

10. The projection device as claimed in claim 1, wherein the filter element rotates along a central axis.

11. The projection device as claimed in claim 1, wherein the first filter region, the second filter region, and the reflective region of the filter element have a same area.

12. The projection device as claimed in claim 1, wherein the first filter region allows blue light beam and red light beam to pass through, and the second filter region allows blue light beam and green light beam to pass through.

13. The projection device as claimed in claim 1, wherein the wavelength-converted beam is yellow light.

14. The projection device as claimed in claim 1, wherein the first color light is red light, and the second color light is green light.

15. The projection device as claimed in claim 1, wherein a surface of the reflective region of the filter element has microstructures.

16. The projection device as claimed in claim 1, wherein the filter element further comprises a full penetration region allowing the excitation beam and the wavelength-converted beam to pass through.

17. The projection device as claimed in claim 1, further comprising a refractive element, a light valve, and a projection lens, wherein the illumination beam passes through the refractive element and is then incident on the light valve, the light valve converts the illumination beam into an image beam, and the projection lens is configured on an optical path of the image beam.

18. The projection device as claimed in claim 17, wherein the refractive element is a lens or curved mirror with a positive refractive power.

19. The projection device as claimed in claim 17, further comprising a refracting mirror, wherein the refracting mirror is located on an optical path of the illumination beam, and the refracting mirror is located between the light splitting element and the refractive element.

20. The projection device as claimed in claim 17, further comprising a total reflection lens, wherein the total reflection lens is located on an optical path of the illumination beam, and the total reflection lens is located between the refractive element and the light valve.
